(19) United States
(12) Patent Application Publication
(10) Pub. No.: US 2026/0083113 A1
(43) Pub. Date: Mar. 26, 2026

(54) Crawling Insect Trapping Device And Method Of Use

(71) Applicant: Shea Finley, Round Rock, TX (US)

(72) Inventor: Shea Finley, Round Rock, TX (US)

(21) Appl. No.: 18/894,214

(22) Filed: Sep. 24, 2024

(51) Int. Cl. A01M 1/02; A01M 1/10

(52) U.S. Cl. CPC A01M 1/02; A01M 1/103

(57) ABSTRACT

A crawling insect trapping device for preventing crawling insects from accessing food for a pet includes a panel and an annular trough. The panel has an upper surface, a lower surface, and a perimeter. The annular trough is attached to and extends upwardly from the upper surface to define a protected area and an outer area upon the upper surface. The food, or a bowl containing the food, can be positioned in the protected area. A liquid can be positioned in the annular trough so that a crawling insect is prevented from entering the protected area.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to insect barrier devices and more particularly pertains to a new insect barrier device for preventing crawling insects from accessing food for a pet. Crawling insects, and ants in particular, are drawn to food and a device that prevents crawling insects from accessing the food is needed and would be beneficial.

### (2) Description of Related Art Including Information Disclosed Under 37 CFR 1.97 and 1.98.

The prior art relates to insect barrier devices. Prior art insect barrier devices include bowls with attached troughs but do not include panels with annular troughs defining a protected area into which food or bowls of food can be positioned.

### BRIEF SUMMARY OF THE INVENTION

An embodiment of the disclosure meets the needs presented above by generally comprising a panel and an annular trough. The panel has an upper surface, a lower surface, and a perimeter. The annular trough is attached to and extends upwardly from the upper surface to define a protected area and an outer area upon the upper surface. The protected area is configured to position food or a bowl containing the food. The annular trough is configured to receive a liquid so that a crawling insect is prevented from entering the protected area.

Another embodiment of the disclosure includes a crawling insect trapping pet feeding system, which comprises a crawling insect trapping device, as per the disclosure above. Food is positioned in the protected area and a liquid is positioned in the annular trough so that a crawling insect is prevented from entering the protected area.

Yet another embodiment of the disclosure include a method of deterring a crawling insect from accessing food for a pet. The method entails provision of a crawling insect trapping device, as per the disclosure above, food for feeding the pet, and a liquid to add to the annular trough. Additional steps of the method include positioning the panel on a substantially horizontal surface, adding the liquid to the annular trough, positioning the food in the protected area, and allowing the pet to eat the food.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWINGS(S)

The disclosure will be better understood and objects other than those set forth above will become apparent when consideration is given to the following detailed description thereof. Such description makes reference to the annexed drawings wherein:

FIG. 1 is an isometric perspective view of a crawling insect trapping device according to an embodiment of the disclosure.

FIG. 2 is a front view of an embodiment of the disclosure.

FIG. 3 is a cross-sectional view of an embodiment of the disclosure.

FIG. 4 is a detail view of an embodiment of the disclosure.

FIG. 5 is an isometric perspective view of an embodiment of the disclosure.

FIG. 6 is a flow diagram for a method utilizing an embodiment of the disclosure.

### DETAILED DESCRIPTION OF THE INVENTION

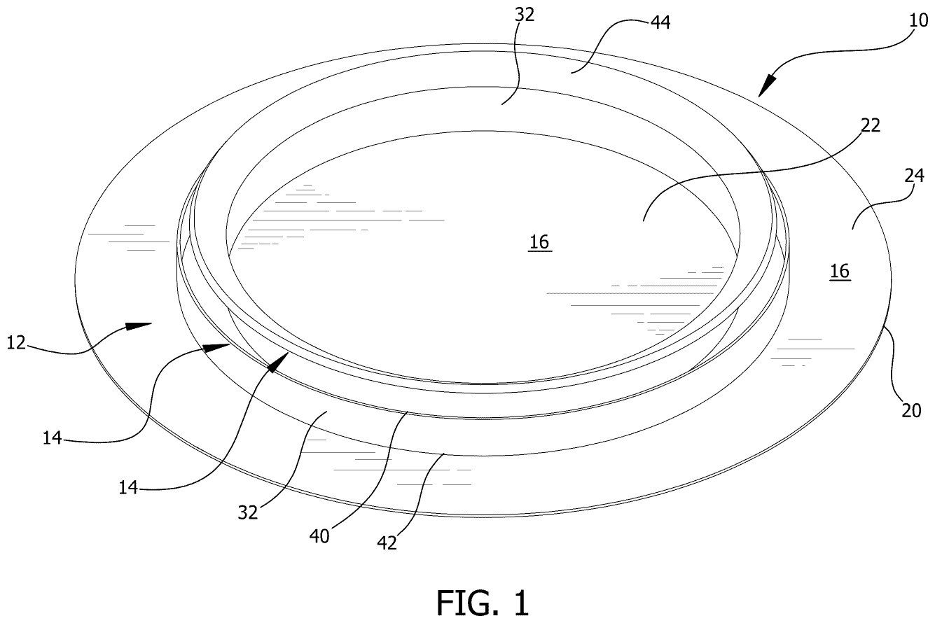

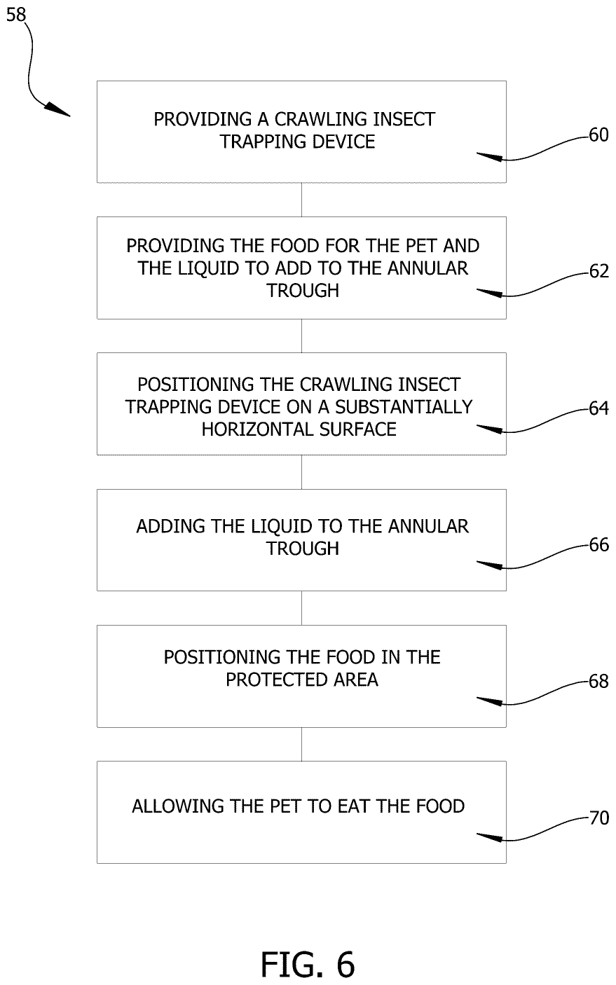

With reference now to the drawings, and in particular to FIGS. 1 through 6 thereof, a new insect barrier device embodying the principles and concepts of an embodiment of the disclosure and generally designated by the reference numeral 10 will be described.

As best illustrated in FIGS. 1 through 6, the crawling insect trapping device 10 generally comprises a panel 12 and an annular trough 14. The panel 12 has an upper surface 16, a lower surface 18, and a perimeter 20. The annular trough 14 is attached to and extends upwardly from the upper surface 16 to define a protected area 22 and an outer area 24 upon the upper surface 16. The protected area 22 is configured to position food 26 or a bowl 28 containing the food 26. It also is anticipated that the bowl 28 could contain water. The annular trough 14 is configured to receive a liquid 30 so that a crawling insect is prevented from entering the protected area 22. Typically, the liquid 30 will comprise water or a solution of water and a detergent.

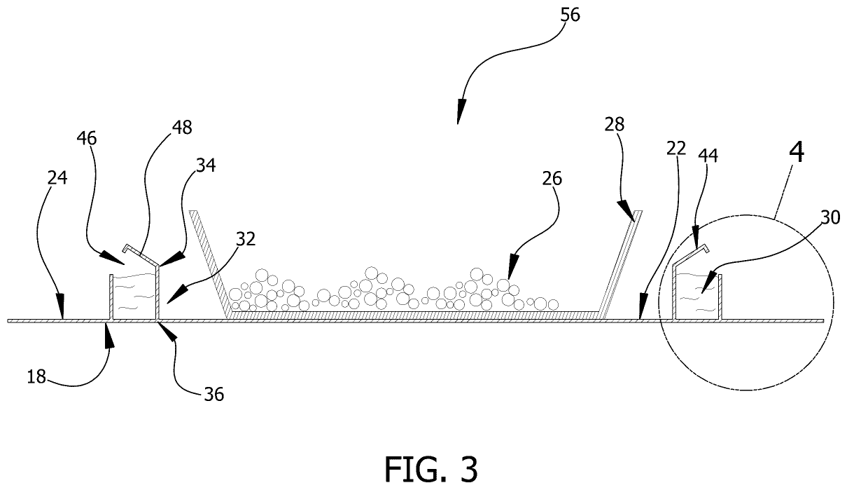

The annular trough 14 comprises an inner wall 32, which has an upper edge 34 and a lower edge 36, and an outer wall 38, which has a top edge 40 and a bottom edge 42. The inner wall 32 may be dimensionally taller than the outer wall 38, as is shown in FIG. 3, and thus be configured to deter the crawling insect from entering the protected area 22 by crawling from the liquid 30 in the annular trough 14 over the upper edge 34 of the inner wall 32. As is shown in FIG. 3, the inner wall 32 and the outer wall 38 extend perpendicularly from the panel 12 so that the annular trough 14 is substantially rectangularly shaped when view in cross-section. The inner wall 32 and the outer wall 38 also may extend angularly from the panel 12 such that the annular trough 14 is V-shaped or trapezoid shaped when view in cross-section.

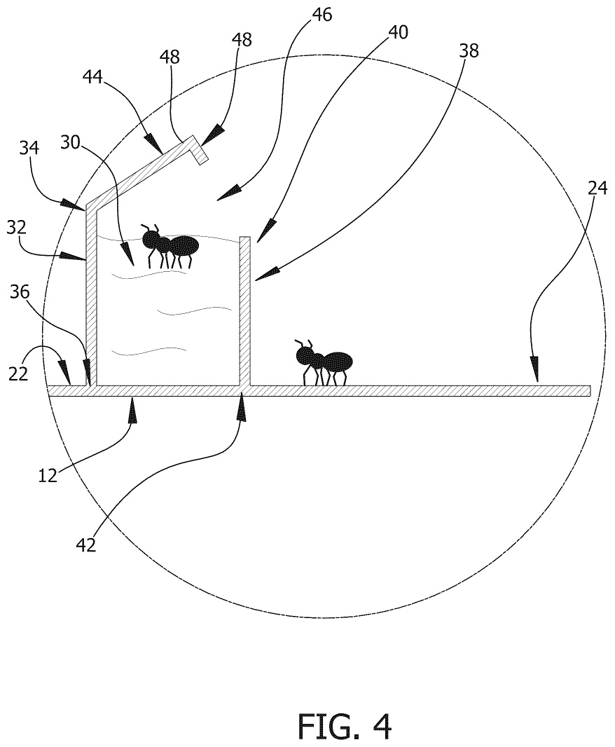

As is shown in FIGS. 3 and 4, a plate 44 is attached to the inner wall 32. The plate 44 extends upwardly and angularly from the upper edge 34 over the annular trough 14 and toward the outer wall 38. The plate 44 and the top edge 40 of the outer wall 38 define a gap 46 through which the crawling insect may enter the annular trough 14 from the outer area 24. The plate 44 is configured to prevent the crawling insect from exiting the annular trough 14 to enter the protected area 22. The plate 44 also deters the pet from drinking the liquid 30 in the annular trough 14 and protects the liquid 30 from contamination by the food 26 as the pet is eating. The plate 44 has a cross-sectional profile 48, which may be elongated L-shaped, as is shown in FIG. 4, arcuate, or the like.

The annular trough 14 and/or the panel 12 may be circular, as is shown in FIG. 1 wherein both the annular trough 14 and the panel 12 are circular. The present invention anticipates alternative shapes for the annular trough 14 and the panel 12. For example, the annular trough 14 and the panel 12 may be rectangular or ovoid and sized to allow for positioning of two bowls 28, one for food 26 and the other for water.

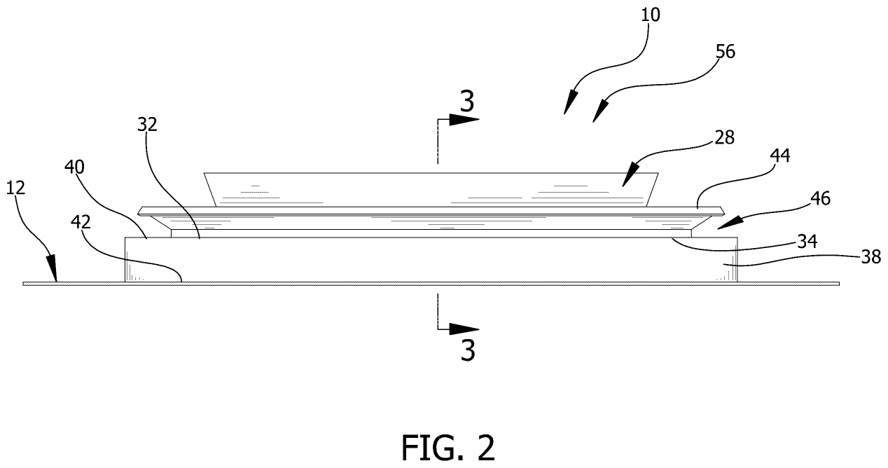

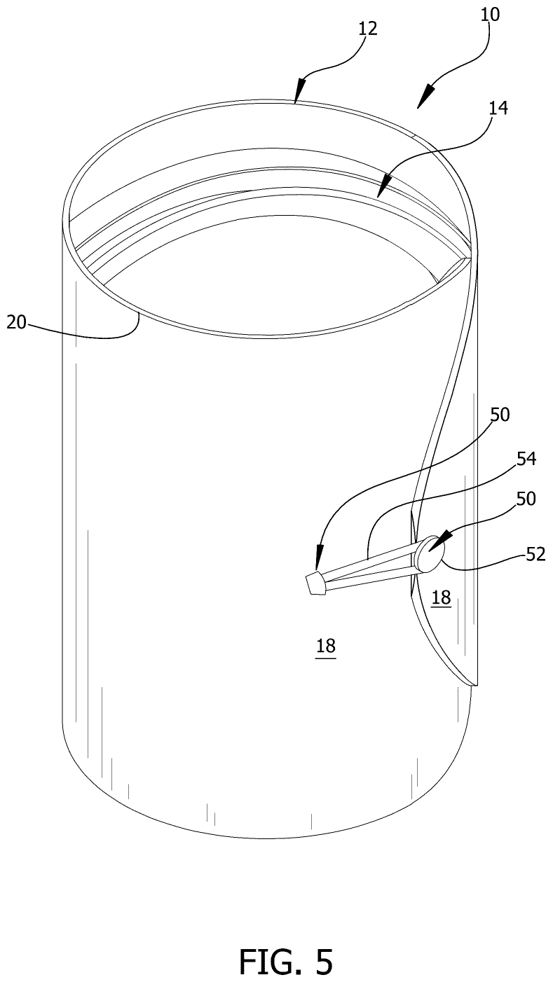

The panel 12 and the annular trough 14 generally comprise elastomer, such as, but not limited to, silicone, rubber, or the like, so that the panel 12 and the annular trough 14 are pliable and reversibly positionable in a deployed configuration, as is shown in FIG. 2 wherein the panel 12 is planer, and a stowed configuration, as is shown in FIG. 5 wherein the panel 12 is rolled upon itself. The crawling insect trapping device 10 being stowable facilitates its transport. However, the present invention also anticipates the panel 12 and the annular trough 14 comprising rigid materials, such as, but not limited to, metal, rigid elastomers, or the like. Crawling insect trapping devices 10 comprised of such rigid materials may be desirable for use in routine feeding environments, such as homes, garages, or the like.

A fastener 50 is attached to the lower surface 18 of the panel 12 to secure the panel 12 and the annular trough 14 in the stowed configuration. The fastener 50 may comprise a button 52 and a string loop 54, as is shown in FIG. 5, or other fastening means, such as, but not limited to hook and loop connectors, snap closures, or the like. The button 52 is attached to the lower surface 18 proximate to the perimeter 20 of the panel 12. The string loop 54 is attached to the lower surface 18 and is opposingly positioned on the lower surface 18 relative to the button 52. The string loop 54 is selectively positionable over the button 52 to secure the panel 12 and the annular trough 14 in the stowed configuration.

The present invention also anticipates a crawling insect trapping pet feeding system 56, which comprises a crawling insect trapping device 10, as per the specification above. Food 26 is positioned in the protected area 22 and a liquid 30 is positioned in the annular trough 14 so that a crawling insect is prevented from entering the protected area 22. The system 56 also may include a bowl 28, which is positioned in the protected area 22 and in which the food 26 is positioned.

The crawling insect trapping device 10 enables a method of deterring a crawling insect from accessing food for a pet 58. The method 58 comprises a first step 60 of providing a crawling insect trapping device 10, as per the specification above. A second step 62 of the method 58 is providing the food 26 for feeding the pet and the liquid 30 to add to the annular trough 14. A third step 64 of the method 58 is positioning the crawling insect trapping device 10 on a substantially horizontal surface with the lower surface 18 of the panel 12 contacting the substantially horizontal surface. A fourth step 66 of the method 58 is adding the liquid 30 to the annular trough 14. A fifth step 68 of the method 58 is positioning the food 26 in the protected area 22. A sixth step 70 of the method 58 is allowing the pet to eat the food 26. When using a bowl 28 to feed the pet, the method 58 includes the additional steps of providing the bowl 28, positioning the bowl 28 in the protected area 22, and adding the food 26 to the bowl 28.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A crawling insect trapping device comprising:
a panel having an upper surface, a lower surface, and a perimeter; and
an annular trough being attached to the upper surface defining a protected area and an outer area upon the upper surface, wherein the protected area is configured for positioning of food or a bowl containing the food and wherein the annular trough is configured for receiving a liquid such that a crawling insect is prevented from entering the protected area, the annular trough comprising an inner wall and an outer wall, the inner wall having an upper edge and a lower edge, the outer wall having a top edge and a bottom edge; and
a plate being attached to the inner wall, the plate extending upwardly and angularly from the upper edge over the annular trough and toward the outer wall, the plate and the top edge of the outer wall defining a gap through which the crawling insect may enter the annular trough from the outer area, wherein the plate is configured for preventing the crawling insect from exiting the annular trough to enter the protected area, a distal edge of said plate relative to said inner wall being vertically spaced over said trough and inset relative to said outer wall.

2. (canceled)

3. The crawling insect trapping device of claim 1 wherein the inner wall is dimensionally taller than the outer wall, wherein the inner wall is configured for deterring the crawling insect from entering the protected area by crawling from the liquid in the annular trough over the upper edge of the inner wall.

4. (canceled)

5. The crawling insect trapping device of claim 1 wherein the plate has a cross-sectional profile, the cross-sectional profile being elongated L-shaped.

6. The crawling insect trapping device of claim 1 wherein the annular trough is circular.

7. The crawling insect trapping device of claim 1 wherein the panel is circular.

8. The crawling insect trapping device of claim 1 wherein the panel and the annular trough are circular.

9. The crawling insect trapping device of claim 1 wherein the panel and the annular trough comprise elastomer such that the panel and the annular trough are pliable and positionable in a deployed configuration, wherein the panel is planer, and a stowed configuration, wherein the panel is rolled upon itself.

10. The crawling insect trapping device of claim 9 wherein the panel and the annular trough comprise silicone or rubber.

11. The crawling insect trapping device of claim 9 further including a fastener being attached to the lower surface of the panel for securing the panel and the annular trough in the stowed configuration.

12. The crawling insect trapping device of claim 11 further including the fastener comprising:
a button attached to the lower surface proximate to the perimeter of the panel; and
a string loop attached to the lower surface and being opposingly positioned on the lower surface relative to the button such that the string loop is selectively positionable over the button for securing the panel and the annular trough in the stowed configuration.

13. The crawling insect trapping device of claim 1 further including:
the annular trough comprising an inner wall and an outer wall, the inner wall having an upper edge and a lower edge, the outer wall having a top edge and a bottom edge, the inner wall is dimensionally taller than the outer wall, wherein the inner wall is configured for deterring the crawling insect from entering the protected area by crawling from the liquid in the annular trough over the upper edge of the inner wall;
a plate being attached to the inner wall, the plate extending upwardly and angularly from the upper edge over the annular trough and toward the outer wall, the plate and the top edge of the outer wall defining a gap through which the crawling insect may enter the annular trough from the outer area, wherein the plate is configured for preventing the crawling insect from exiting the annular trough to enter the protected area, the plate has a cross-sectional profile, the cross-sectional profile being elongated L-shaped, the panel and the annular trough being circular,
the panel and the annular trough comprising silicone or rubber such that the panel and the annular trough are pliable and positionable in a deployed configuration, wherein the panel is planer, and a stowed configuration, wherein the panel is rolled upon itself;
a button being attached to the lower surface proximate to the perimeter of the panel; and
a string loop being attached to the lower surface and opposingly positioned on the lower surface relative to the button such that the string loop is selectively positionable over the button for securing the panel and the annular trough in the stowed configuration.

14. (canceled)

15. (canceled)

16. (canceled)

17. (canceled)
